(19) United States
(12) Patent Application Publication
(10) Pub. No.: US 2016/0047462 A1
(43) Pub. Date: Feb. 18, 2016

(54) Gear Wheel with Meshing Teeth

(71) Applicant: SETTIMA MECCANICA S.R.L. - SOCIETÀ A SOCIO UNICO, Gossolengo (Piacenza) (IT)

(72) Inventor: Pierpaolo CAGNANI, Piacenza (IT)

(73) Assignee: Settima Meccanica S.r.l. - Societa a Socio Unico, Gossolengo (Piacenza) (IT)

(21) Appl. No.: 14/778,838

(22) PCT Filed: Aug. 29, 2013
(86) PCT No.: PCT/IB2013/001876

§ 371 Date: Sep. 21, 2015

(30) Foreign Application Priority Data
Mar. 22, 2013 (EP) 13160658.4

(51) Int. Cl. F16H 57/04; F04C 15/00; F04C 2/08; F04C 2/18; F16H 55/17; F16H 57/00

(52) U.S. Cl. CPC F16H 57/0495; F16H 55/17; F16H 57/0031; F04C 2/084; F04C 2/18; F04C 15/0088

(57) ABSTRACT

The invention concerns a gear wheel (2) having a plurality of identical teeth suitable for meshing in parallel with a similar second gear wheel in a casing (3) of a hydraulic machine, said gear wheel having a side face of the front toothing (21) and a side face of the rear toothing (22) suitable for dragging in rotation against a front bush (41) and a rear bush (42), respectively, said bushes (41, 42) being slotted onto a sleeve (20) fixedly connected to the gear wheel (2), said helical teeth extending along the entire gear wheel (2) between the front side face (21) and the rear side face (22), where both the side face of the front toothing (21) and the side face of the rear toothing (22) have, at each tooth, a removed rotor portion (2a, 2b, 2c), so as to have an area of the side faces of the toothing that does not come into contact with the bush when the latter is placed in abutment against the respective side face of the toothing of the gear wheel.

The present invention concerns a gear wheel with helical teeth suitable for meshing with a second gear wheel in a casing of a hydraulic machine, in particular a positive displacement pump.

The invention also concerns a method for improving the distribution of lubricant liquid in the contact area between a helical gear wheel or one with straight teeth and the bushes (or support bushings of said gear wheel) in a hydraulic machine, like for example a rotary positive displacement pump, incorporating said gear wheels and said bushes or support bushings of said gear wheel.

### PRIOR ART

The present invention centres on a technical field that concerns rotary positive displacement pumps with gear wheels or similar hydraulic machines. This type of pump generally comprises two gear wheels, one of which, known as driving wheel, is connected to a drive shaft and sets in rotation the other wheel, known as driven wheel. The two wheels comprise respective shafts or sleeves normally supported by bushes (also known as support bushings).

During operation, thanks to the difference between the pressures acting on the two outer and inner faces, the bushes are pressed with a controlled force against the gear wheels, so as to reduce to the minimum the leaking of liquid along the side faces of the gear wheels themselves, due to the pressure difference between intake and delivery.

One of the main objectives in the manufacture of this type of pumps is to obtain a good seal between intake and delivery; indeed, the efficiency of such pumps rapidly decreases if such a seal is not adequate.

Keeping this seal between delivery and intake is more complex when operating with high pressures typically greater than 80 bar and at high speeds, for example over 1000 RPM, and moreover it has been seen that with these pressures even a low number of revs, like for example less than 200 rpm, it leads to a rapid deterioration of the seal between delivery and intake.

In the working conditions described above, there can be wearing of the bushes in the contact area with the rotors, which at high pressures degrade the surface roughness of the bushes increasing it, with consequent sudden damage to the seal ensured in as-new condition.

The cause provoking the increased surface roughness of the areas of the bushes in contact with the rotors is caused by the loss of optimal distribution of the lubricant liquid that circulates in the pump between the rotor and the bushes or support bushings (self-lubricating fluid film), in the demanding conditions given as an example above.

Another problem faced by manufacturers of pumps is the noise of the pumps themselves, due to phenomena of irregularities, or “ripple”, in the transfer of fluid: this problem consists of the noise of operation caused by the instantaneous oscillations in flow rate over time, better known as ripple noise. The aforementioned oscillations generate a pulsating wave that, through the fluid, transmits to the surrounding environment and, in particular, to the walls of the pump, to the pipes and to the delivery ducts. The noise induced can even reach unpredictable levels in the case in which the aforementioned members go into resonance with the oscillation or ripple frequency.

Such an oscillation phenomenon of the axial thrusts, normally of small size in geared pumps with straight teeth, becomes much more substantial in the case of geared pumps with helical teeth, in which the meshing between the gear wheels is the cause of both mechanical and hydraulic axial thrusts such that the balancing and recovery of clearances on the bushes is not entirely satisfactory, since the hydraulic axial thrusts have substantial pulsations.

The prior art has in the past proposed some solutions that have attempted to solve the problems highlighted earlier.

For example, American patent U.S. Pat. No. 2,159,744 to Maglott, which dates back to May 1939, has the objective of making gear wheels for positive displacement pumps with external gears that are capable of avoiding, or at least reducing, the phenomenon of encapsulation of fluid in the harmful space (without compromising the transmission between the two wheels) and at the same time of making the flow rate processed by the pump itself more uniform.

To deal with the problem of encapsulation it is proposed to create a tooth profile characterised by a central portion as an involute to a circle and by two joining portions (top and bottom of the tooth) as an arc of circle of equal radius; it is also specified that the centre of these arcs must be positioned outside the primitive diameter of the gear wheel for joining at the top, and it must, on the other hand, be inside such a primitive diameter for the arc of circle at the bottom. Maglott also specifies that, in order to ensure continuity of motion, it is necessary to use helical toothings with helix coverage greater than or equal to 0.5.

A second prior art document is represented by American patent U.S. Pat. No. 3,164,099 to Hitosi dating back to January 1965. Hitosi sets itself the task of improving the performance of a gear pump, eliminating the problem of encapsulation and ensuring a more uniform flow rate over time.

More specifically, this patent provides a graphical/analytical method by which to outline the profile of a tooth—see the details of FIGS. 10 to 15 of the Hitosi patent, as well as the formulae inserted in the text in columns 5 and 6.

A further patent n° EP 1 371 848 to Morselli concerns the field of gear pumps and proposes simply to indicate a band formed from a theoretical profile for making gear wheels that mesh without encapsulation. By encapsulation, we mean the closed space, located between the top of the teeth of one wheel and the base of the teeth of the matching wheel, a space that is unwanted if the pump is to operate correctly and less noisily.

This noisiness is caused essentially by the instantaneous oscillation of the flow rate over time, better known as ripple noise. The aforementioned oscillation generates a pulsating wave that is transmitted through the fluid to the surrounding environment and, in particular, to the walls of the pump, to the pipes and to the delivery ducts. The induced noise can even reach unpredictable levels in the case in which the aforementioned members go into resonance with the oscillation or ripple frequency.

Patent EP'848 was indeed the first to present a solution to such a problem by describing a theoretical profile of a tooth from which a band is obtained for the creation of toothed profiles of the wheels of a silent pump.

As well as the aforementioned problems, in this type of pump there is the further need to optimise the distribution of the working fluid, which is also a lubricant fluid, on the contact surfaces between the bushes and the side faces of the rotors.

Currently, the prior art proposes to make the surfaces of the rotors and the surfaces of the bushes with a particularly low surface roughness, using specific machine tools for the rotors to make the suitable surface finish, or mechanical or chemical polishing systems. Similar techniques are also used for the surface finishing of the surfaces of the bushes in sliding contact with the rotors.

Although advantageous from some points of view, these solutions are particularly expensive and burdensome to make in terms of time and effort and in any case they do not allow the distribution of the fluid to be optimised when operating at high pressures (over 80 bar) with high speeds (over 1000 rpm) or low speeds (below 200 rpm).

The technical problem at the basis of the present invention is to devise a gear wheel having a plurality of identical teeth suitable for meshing in parallel with a second gear wheel in a casing of a hydraulic machine capable of allowing the lubrication in the contact area with the bushes even when operating with high pressure and at high and low rotation speeds, so as to be able to make pumps with an improved lifetime and with a positive displacement efficiency that remains sufficiently high even after prolonged use under the conditions described above, within the framework of a simple and rational constructive solution.

### SUMMARY OF THE INVENTION

The idea for a solution forming the basis of the present invention is to facilitate the creation of a lubricating gap that is created between the rotors of gear pumps, preferably having helical teeth, and the bushes against which the faces of the rotors slide.

In order to improve the creation of the lubricating gap, and to reduce the wear of the surfaces of the bushes, the edge of the teeth of the rotors is smoothed through the use of machine tools or mechanical finishing systems.

Advantageously, it is also possible to foresee a variation of the overall surface of the side face of the rotor and consequently of the surface of its edges and the creation of suitable recesses that form pockets that have the purpose of receiving the oil and distributing it on the contact surface with the bushes.

The characteristics and advantages of the gear wheel according to the invention will become clearer from the description, made hereafter, of an example embodiment given for indicating and not limiting purposes with reference to the attached drawings.

### BRIEF DESCRIPTION OF THE DRAWINGS

FIG. 1 shows a schematic longitudinal section view of a geared positive displacement pump made according to the present invention;

FIG. 2 shows a schematic perspective view of a pair of meshing gear wheels, with the bushes slotted onto the respective sleeves, used in the pump of FIG. 1;

FIG. 3A shows a schematic perspective view of a gear wheel in accordance with a first embodiment of the present invention;

FIG. 3B shows a side view of the gear wheel of FIG. 3A;

FIG. 3C shows a detail of the profile of a tooth shown in FIG. 3B;

FIG. 3D shows a front view of the gear wheel of FIG. 3A;

FIG. 3E shows a detail of the profile of a tooth shown in FIG. 3D;

FIG. 4A shows a schematic perspective view of a gear wheel in accordance with a second embodiment of the present invention;

FIG. 4B shows a side view of the gear wheel of FIG. 4A;

FIG. 4C shows a detail of the profile of a tooth shown in FIG. 4B;

FIG. 4D shows a front view of the gear wheel of FIG. 4A;

FIG. 4E shows a detail of the profile of a tooth shown in FIG. 4D;

FIG. 5A shows a schematic perspective view of a gear wheel in accordance with a third embodiment of the present invention;

FIG. 5B shows a side view of the gear wheel of FIG. 5A;

FIG. 5C shows a detail of the profile of a tooth shown in FIG. 5B;

FIG. 5D shows a front view of the gear wheel of FIG. 5A;

FIG. 5E shows a detail of the profile of a tooth shown in FIG. 5D.

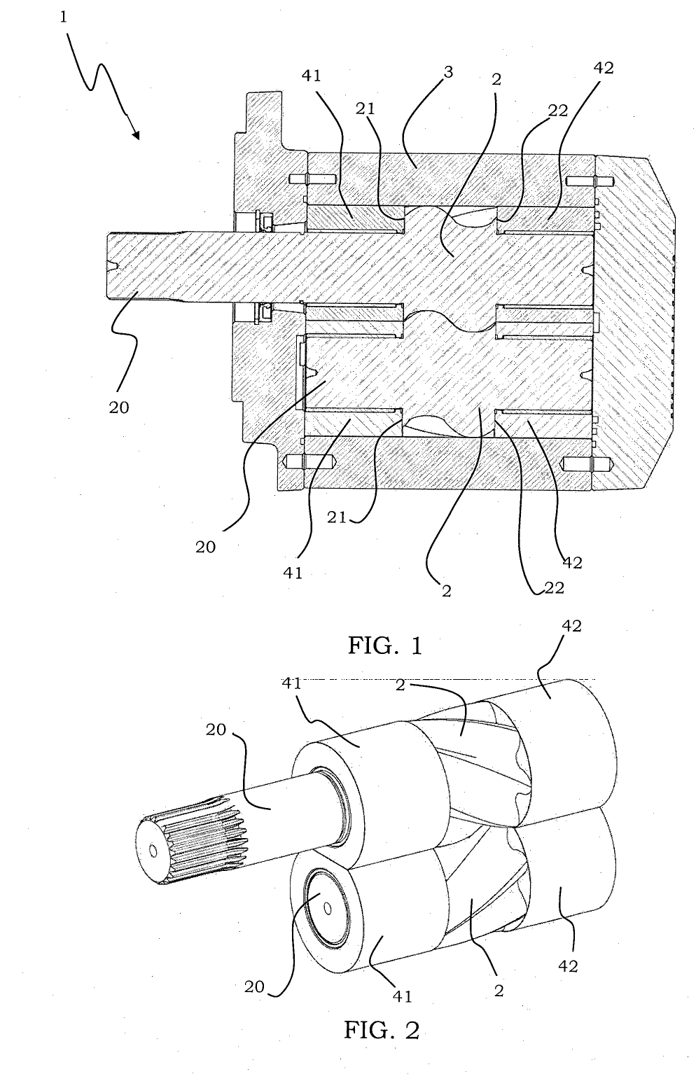

### DETAILED DESCRIPTION

With reference to FIG. 1, reference numeral 1 globally and schematically indicates a rotary positive displacement pump with helical gear wheels made according to the present invention. The following description is also valid for positive displacement pumps with non-helical rotors.

The pump 1 comprises a pair of gear wheels 2, one known as driving wheel, connected to a drive shaft 20, and one known as driven wheel, being supported by a relative shaft 20 and set in rotation by the driving wheel. The gear wheels 2 are housed in a casing 3 and supported in rotation by a pair of bushes 41, 42 slotted onto the two shafts and opposing one another adjacent to the two sides of the gear wheels 2.

In order to ensure the seal between the gear wheels 2 and the bushes 41, 42 arranged at the sides, it is necessary for the latter to be pressed as much as possible against the side faces of the toothing of the gear wheels 2.

In practice, the bushes 41, 42 are pressed against the side face of the front toothing 21 and against the side face of the rear toothing 22 of each gear wheel 2, in this way during the rotation of the two gear wheels 2 there is sliding of the side faces of the toothing against the sides of the bushes 41, 42.

The gear wheels are of the type with helical teeth that extend along the entire gear wheel 2 between the front face 21 and the rear face 22.

Normally, according to the prior art, the side faces of the toothing 21, 22 of the gear wheels or rotors 2 and the faces of the bushes 41, 42 are made with a particularly low surface roughness, using specific machine tools or mechanical or chemical polishing systems to make the suitable surface finish and, again according to the prior art, they have a flat surface.

In the present invention by side face of the toothing we mean the annular portion shaped like a crown of the gear wheel that goes into abutment against the bush slotted onto the sleeve.

In practice, the side face of the toothing is the side of the gear wheel that during rotation rubs on the face of the bush.

In accordance with the present invention, both the front side face 21 and the rear side face 22 have a portion of the side of the rotor removed at each tooth, so as to have an area of the side faces of the toothing that does not come into contact with the bush 41 when the latter is placed in abutment against the respective side face of the toothing of the gear wheel.

In accordance with a first embodiment of the present invention, the removed portion on the sides of the gear wheel is in the form of a recess 2a for each tooth. The recess 2a is formed on both side faces of the gear wheel, as well as on both faces of the meshing gear wheel.

In particular, each recess 2a has an arched profile “w” that departs from a point “x” close to the bottom of a tooth and ends close to the apex “y” of the tooth itself. This recess 2a has a variable depth that increases going from the arched profile “y” towards the profile of the tooth.

Basically, the recess 2a has a chute-type configuration with the maximum recorded depth along the profile of the tooth engaged by the recess.

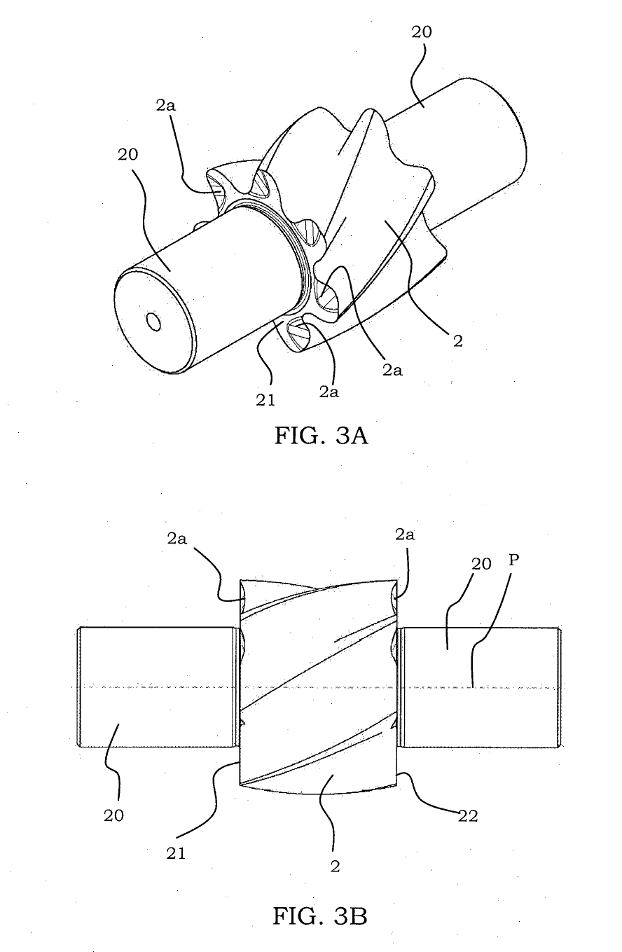

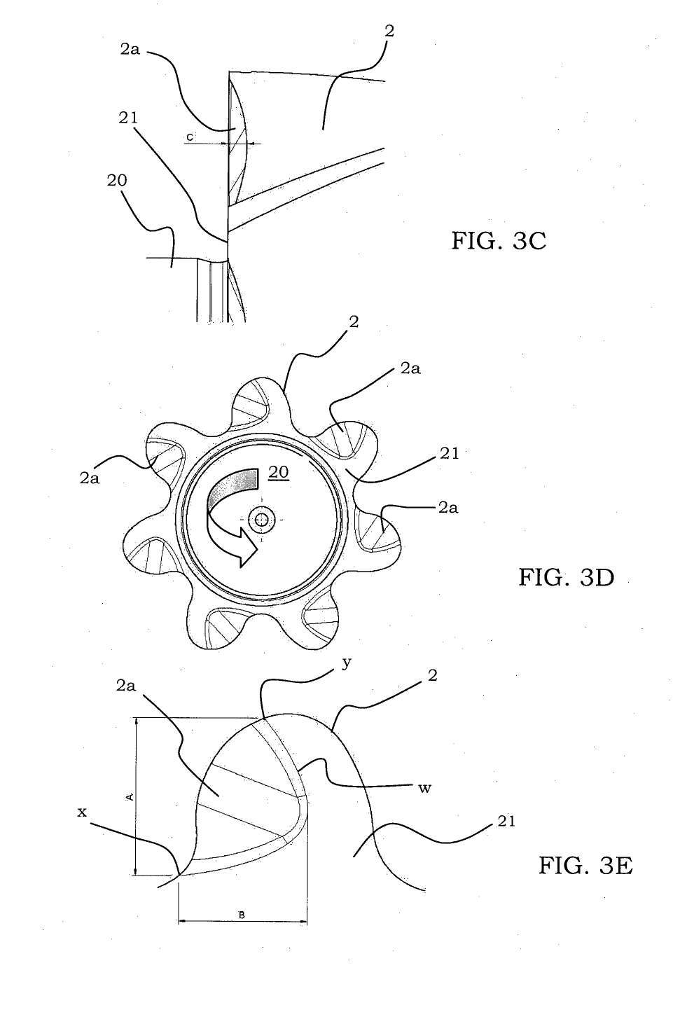

In order to improve the drawing of the lubricant liquid moved by the gear wheels, these recesses 2a or chutes are formed in the attachment area of the tooth with respect to the direction of rotation of the gear wheel indicated with an counterclockwise arrow in FIG. 3D.

In practice, the chutes 2a are arranged on the portion of the teeth of the gear wheel that first engages with the teeth of the meshing gear wheel.

In terms of size, each chute 2a has a maximum depth “C” measured along a rotation axis P of the gear wheel 2 that is greater than 0.01 mm (FIG. 3C) and a surface extension of more than 1 mm².

As an example, but not limiting what is covered by this invention, for a gear wheel having a diameter of about 72 mm it is possible to have a depth “C” equal to about 0.2 mm (FIG. 3C), and a surface equal to about 70 mm², obtained with an arched profile “w” having a maximum width “B” of about 7.7 mm and a maximum height “A” of about 13.3 mm (FIG. 3E).

It is also opportune if there is a regular curvature in the joining point between the step 2a and the surface of the side 21 of the gear wheel 2 not engaged in the recess, i.e. along the arched profile “w”, thereby avoiding that possible steps are created.

In accordance with a second embodiment of the present invention, the removed portion on the sides of the gear wheel is in the form of a chamfer 2b uniformly distributed along the entire perimeter of the side faces of the toothing. The chamfer 2b is formed on both side faces of the gear wheel, as well as on both faces of the meshing gear wheel.

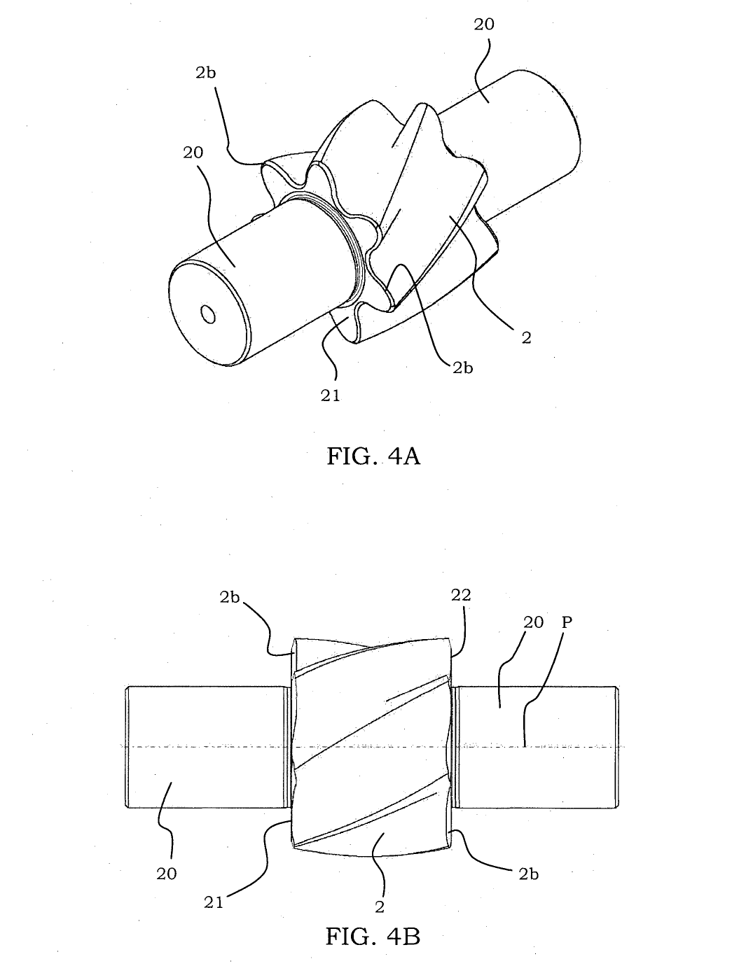

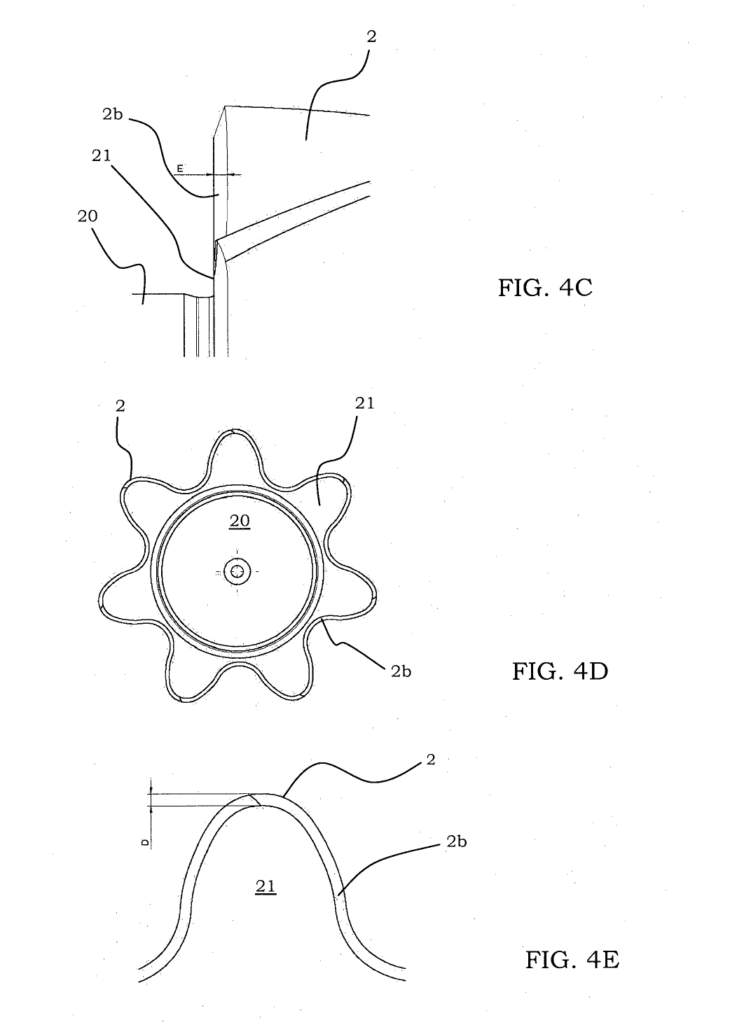

The depth “E” of the chamfer 2b measured along the rotation axis P of the gear wheel 2 from the edge before the chamfer has been formed (FIG. 4C) is less than the height “D”, measured in the radial direction towards the centre of rotation of the gear wheel starting from the edge before the chamfer is present.

In practice, the chamfer 2b consists of removing the perimeter edge along the entire profile of the teeth of the gear wheel, so as to create a chute in which the oil can be channelled, with the relevant characteristic of having the depth “E” smaller than the height “D” of the chamfer 2b.

As an example, but not limiting what is covered by this invention, for a gear wheel having a diameter of about 72 mm it is possible to have a depth “E” equal to about 0.04 mm (FIG. 4C), and a height “D” equal to about 0.4 mm (FIG. 4E).

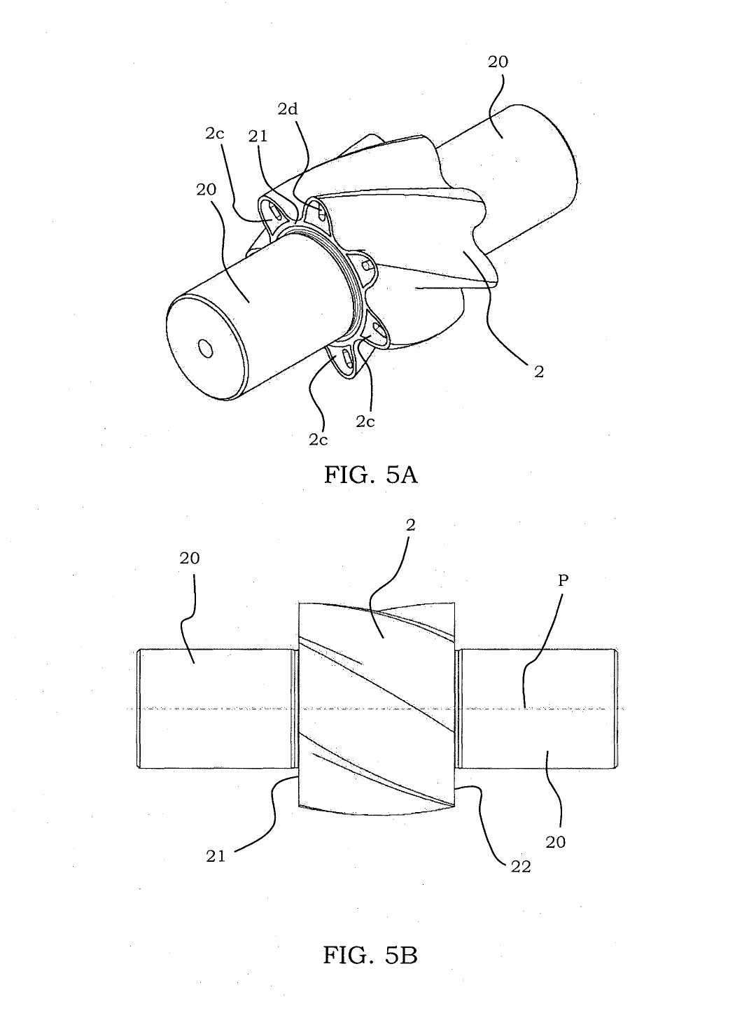

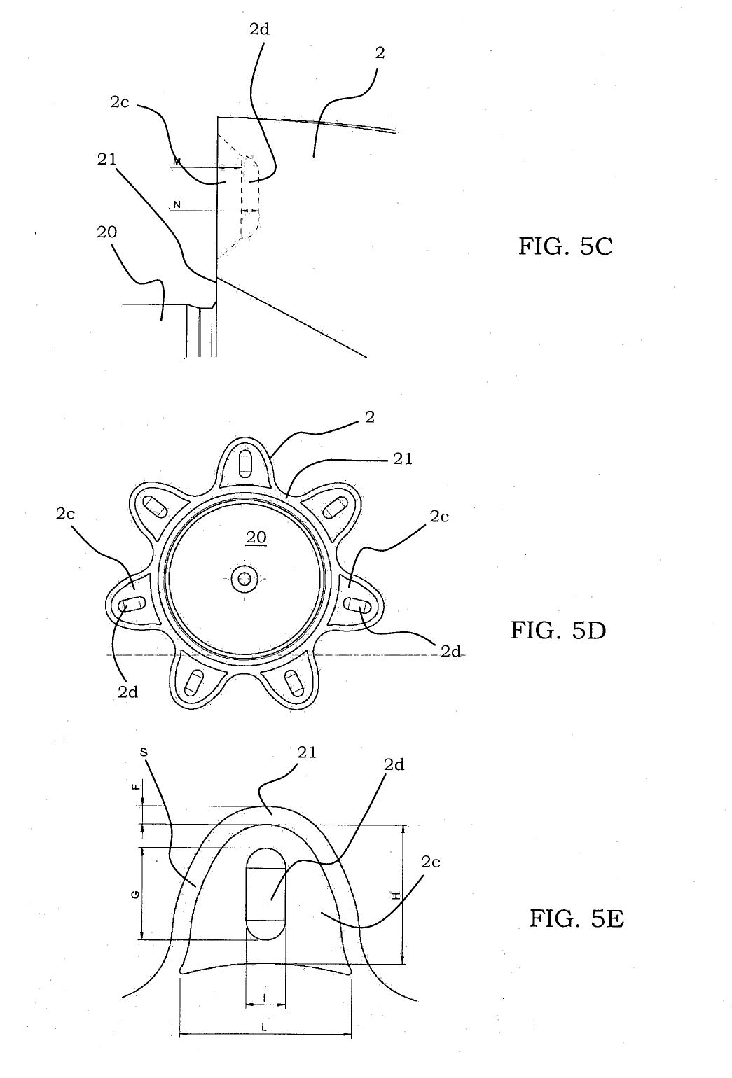

In accordance with a third embodiment of the present invention, the removed portion on the sides of the gear wheel is in the form of a recess having a closed profile “s” (FIG. 5E) at each tooth.

This recess is in the form of a niche 2c the depth of which increases from the closed profile “s” of the niche 2c towards the centre of the pocket itself.

In practice, the niches 2c receive the lubricant liquid. These niches 2c are formed on both the side faces of the gear wheel, as well as on both the faces of the meshing gear wheel.

In order to best retain the lubricant liquid, inside each niche 2c a groove 2d is formed centrally, entirely contained in the niche itself.

In terms of size, the niche 2c has a maximum depth “M” (FIG. 5C) measured along the rotation axis P of the gear wheel 2 of more than 0.01 mm and a surface extension of more than 2 mm². The profile “s” of the niche is arranged at a distance “F” from the profile of the tooth of the gear wheel of more than 0.01 mm (FIG. 5E).

The groove 2d has a maximum depth “N” (FIG. 5C), measured along the rotation axis P of the gear wheel 2, of more than 0.01 mm, starting from the bottom of the niche 2c and a surface extension of more than 0.05 mm².

As an example, for a gear wheel having a diameter of about 72 mm it is possible to have a maximum depth “M” of the niche 2c equal to about 2 mm (FIG. 5C), and the profile “s” of the niche 2c can be equidistant at a distance from the profile of the tooth equal to about 1.4 mm. The profile “s” of the niche has a height “H” equal to about 10.6 mm and a width “L” equal to about 13.1 mm (FIG. 5E). The groove 2d can have a maximum depth “N” equal to about 0.2 mm (FIG. 5C), with a height “G” equal to about 6 mm and a width “I” equal to about 2 mm (FIG. 5E).

In accordance with a fourth embodiment of the present invention, it is possible to have gear wheels that simultaneously have both a chamfer along the entire perimeter edge of the teeth (like in the second embodiment described above) and the creation of the chutes in accordance with the first embodiment described above.

In accordance with a fifth embodiment of the present invention, it is possible to have gear wheels that simultaneously have both a chamfer along the entire perimeter edge of the teeth (like in the second embodiment described above) and the creation of niches in accordance with the third embodiment described above.

Operatively, making the chutes 2a can be carried out by means of machining processes by simple machine tools.

The niches 2c can be made by pressure moulding and/or machining by machine tool.

As can be appreciated from what has been described, the gear wheel according to the present invention makes it possible to satisfy the requirements and to overcome the drawbacks mentioned in the introductory part of the present description with reference to the prior art.

Indeed, thanks to the creation of a removed and/or recessed rotor area on the side faces of the toothing of the gear wheel, the lubrication of the contact area between rotor and bush is considerably improved, as a lubricant gap is created for the pumped liquid that is maintained during the relative sliding between the rotor/bush contact surfaces even in high pressure conditions both for high sliding speeds and for low sliding speeds.

As an example, a pump that adopts gear wheels made in accordance with the present invention can operate without loss of positive displacement efficiency at pressures of 280 bar and 3600 rpm, and at pressures of 200 bar and 50 rpm.

Of course, a person skilled in the art can bring numerous modifications and variants to the gear wheel described above in order to satisfy contingent and specific requirements, all of which are in any case covered by the scope of protection of the invention as defined by the following claims.

1. A Gear wheel having a plurality of identical teeth suitable for meshing in parallel with a similar second gear wheel in a casing of a hydraulic machine, said gear wheel having a side face of the front toothing and a side face of the rear toothing suitable for dragging in rotation against a front bush and a rear bush respectively, said bushes being slotted onto a sleeve fixedly connected to the gear wheel, said helical teeth extending along the entire gear wheel between the front side face and the rear side face, wherein both the side face of the front toothing and the side face of the rear toothing have, at each tooth, a rotor portion removed, so as to have an area of the side faces of the toothing that does not come into contact with the bush when the latter is placed in abutment against the respective side face of the toothing of the gear wheel.

2. The gear wheel according to claim 1, wherein said removed portion comprises a chamfer uniformly distributed along the entire perimeter of the side faces of the toothing.

3. The gear wheel according to claim 1, wherein said removed portion comprises a recess for each tooth, said recess being formed on the two side faces of the toothing at each tooth, each recess forming a chute that receives the lubricant fluid when the corresponding side face of the toothing is brought close up to the bush.

4. The gear wheel according to claim 3, wherein each chute has an arched profile (w) that departs from a first point (x) close to the bottom of a tooth and ends at a second point (y) close to the apex of the tooth itself, said chute having a variable depth (C) that increases going from the arched profile (w) towards the profile of the tooth.

5. The gear wheel according to claim 3, wherein each chute is formed in the attachment area of the tooth with respect to the direction of rotation of the gear wheel.

6. The gear wheel according to claim 3, wherein each recess has a maximum depth (C) measured along the rotation axis (P) of the wheel of more than about 0.01 mm and a surface extension of more than about 1 mm2.

7. The gear wheel according to claim 1, wherein said removed portion comprises a recess with closed profile (s), forming a niche at each tooth, each niche having a depth (M) measured along the rotation axis (P) of the wheel that increases going from the closed profile (s) of the niche towards the centre of the niche itself.

8. The gear wheel according to claim 7, wherein each niche has the maximum depth (M) measured along the rotation axis (P) of the wheel of more than about 0.01 mm and a surface extension of more than about 2 mm², said closed profile (s) of the niche being formed a distance (F) from the profile of the tooth of more than about 0.01 mm.

9. The gear wheel according to claim 7, wherein inside the niche a further groove is formed centrally.

10. The gear wheel according to claim 9, wherein said further groove has a maximum depth (N) measured along the rotation axis (P) of the wheel of more than about 0.01 mm beginning from the bottom of the niche (and a surface extension of more than 0.05 mm².

11. The gear wheel according to claim 1, wherein said removed portion comprises both a chamfer uniformly distributed along the entire perimeter of the side faces of the toothing, and a chute, said chute being formed on the two side faces of the toothing at each tooth, each chute being suitable for receiving the lubricant fluid when the side face of the toothing is brought up to the corresponding bush.

12. The gear wheel according to claim 1, wherein said removed portion comprises both a chamfer uniformly distributed along the entire perimeter of the side faces of the toothing, and a niche at each tooth, each niche with a closed profile (s) having a depth (M) that increases going from the closed profile (s) of the niche towards the centre of the niche itself.

13. A method for improving the distribution of lubricant fluid in the contact area between the side face of the toothing and a corresponding bush in a hydraulic machine, wherein it includes the step of removing a portion of material of the tooth both on the side face of the rear toothing and on the side face of the front toothing so as to create an area on the side faces of the toothing that does not come into contact with the bush when it is placed in abutment against the respective side face of the toothing of the gear wheel.

14. The method according to claim 13, wherein said removal step comprises the creation of a chamfer uniformly distributed along the entire perimeter of the side faces of the toothing.

15. The method according to claim 13, wherein said removal step comprises the creation of a recess at each tooth, said recess having an arched profile (w) that departs from a point (x) close to the bottom of a tooth and ends close to another point (y) close to the apex of the tooth itself, with a variable depth that increases going from the arched profile (w) towards the profile of the tooth.

16. The method according to claim 13, wherein said removal step comprises the creation of a niche at each tooth, said niche having a closed profile (s), the depth of each niche increasing going from the closed profile (s) of the niche towards the centre of the niche itself.

17. A geared rotary positive displacement pump comprising a pair of gear wheels with helical teeth, respectively connected to a drive shaft for driving, and driven, set in rotation by the driving wheel, said gear wheels being supported by a respective sleeve on which a respective pair of opposite bushes are slotted, each gear wheel comprising the characteristics according to claim 1.
